(19) United States
(12) Patent Application Publication
(10) Pub. No.: US 2003/0212600 A1
(43) Pub. Date: Nov. 13, 2003

(54) Method and system of communicating individual address information

(76) Inventors: William H. Hood III, Palm Harbor, FL (US); Charles Acosta, Clearwater Beach, FL (US); Richard Flaherty, Tampa, FL (US)

Correspondence Address: BAKER & BOTTS, 30 ROCKEFELLER PLAZA, NEW YORK, NY, 10112

(21) Appl. No.: 10/143,718

(22) Filed: May 10, 2002

(51) Int. Cl. G06F 17/60

(52) U.S. Cl. 705/15

(57) ABSTRACT

This invention provides a system and method for communicating a mover's address information. In one aspect, the method includes receiving a mover's inbound call from a channel partner and obtaining information from the mover through a script of questions that is specifically tailored to the particular channel partner. In addition, services provided by a channel partner can be offered reflecting the mover's particular stage of moving. Furthermore, a mover's change of address information is forwarded to at least one correspondent specified by the mover.

### FIELD OF THE INVENTION

This application relates to methods and systems for communicating an individual's address information to one or more correspondents. More particularly, this invention relates to consolidated methods and systems for communicating a mover's change of address information among correspondents and consolidating offers for services by business entities.

### BACKGROUND

When individuals relocate their residencies or businesses, they are typically confronted with the additional difficulty of providing the phone, cable, gas and electric companies, and other businesses and correspondents with their new address and date of their move. It is typically necessary for the mover to contact a new provider of services to establish a new account before the new services can be provided. In addition, a mover also typically needs to convey change of address information to correspondents to ensure that mail and other correspondence is sent to the proper address. These ancillary activities add time-consuming complexity to an already difficult process of moving since the mover must often contact these providers and correspondents individually to ensure the appropriate change of address information is recorded.

The habits of a typical mover engaged in a moving process can be generally characterized by a process having several-moving stages. Identification of these moving stages is important for identifying the channels through which a mover may be contacted and for associating services that are most appropriate to the mover with a particular moving stage.

A first stage can be generally characterized as a planning stage. Planning is generally the thought process wherein a mover decides upon the circumstances that dictate the actual move. The planning stage includes an evaluation process of determining the need for moving and then conducting a search for a new residence or business. In the planning stage, the mover may contact a real estate agent for locating a residence, or a bank for financing a purchase.

A second stage can be characterized as a pre-move stage. The pre-move stage is the stage wherein all the precursor activities are performed before the actual move. As part of the activities, the mover identifies products and services to prepare for the new home or business location and the actual move. For example, contracts for sale can be completed utilizing a broker, a lawyer, or a bank. In addition, arrangements with a moving company may be made for the actual move. The mover may notify the local United States Post Office branch of the new address and the date to begin forwarding mail. During this stage, the mover also may contact utilities and other such companies to establish disconnect dates for services at the old residence or business location and likewise, set up connection dates for services in the new residence if the utilities service the new residence.

A third stage is the actual move. Movers generally have a short window where they must be out of their current home and moved into their new home. Accordingly, the mover is typically out of contact at this stage unable or unwilling to seek out new services.

A fourth stage can be generally characterized as a settling-in stage. Typically, many of a mover's belongings remain in boxes, mail has yet to be forwarded, and utilities such as cable and phone typically have not been turned on. For most movers, many transactions associated with the move, such as acquiring new goods and services, are made during this period of time.

A fifth and final stage can be characterized as the post-move, in which movers have become accustomed to their new surroundings and have obtained the goods and services that are associated with a move. It is at this stage in the move that typical businesses and utilities are most aggressive in marketing their goods and services to the mover. Businesses and utilities generally act at this final stage because circulation of a mover's change of address information is delayed since it is first distributed through other third party agencies who are first contacted by the mover for critical services, such as local phone service. Accordingly, marketers are unable to identify the mover until the later stages when the mover's change of address information has been generally dispersed.

This timeline shows that there are few entry points where marketers can reach movers for offering their services, and shows why marketers typically fail to contact the mover until it is too late. For example, prior to the settling-in period, movers are generally dealing with regional and decentralized companies such as real estate agencies, moving companies and utilities and generally do not interact with large, centralized information-gathering companies such as credit card issuers and insurance companies until the final stages of the move. As a result, marketers who can obtain mover information from the centralized information-gathering companies cannot contact movers until after most goods and services associated with a move have already been acquired by the mover.

Another problem is that companies marketing their products typically focus on one part of the mover's timeline and only for a limited number of services. Accordingly, movers find themselves actively searching out products and service providers, rather than being met by one voice that offers them a turnkey solution for most of their needs. Another problem with the preexisting method is that marketers must duplicate resources by providing call centers that wait for a mover to call and provide change of address information. This is an inefficient and less effective allocation of resources.

Accordingly, a consolidated method and system is needed for communicating changes in address information that simplifies the moving activities for the mover, while also availing service providers with more and better opportunities to market their services in a more efficient manner through, among other things, better targeting and reducing the overhead of maintaining duplicative call centers.

### SUMMARY OF THE INVENTION

A system and method of communicating individual address information is provided that permits a mover to make a single call for communicating changes in address information to businesses and individuals. In addition, the system and method leverage a core infrastructure to maximize the lifetime value of a mover's inbound call within a marketing window that is created during the inbound call. In addition, the system and method provide a transactional platform that aggregates new mover demand and provides commercial partners with a channel for effectively targeting specific products within the mover market at appropriate stages.

By providing for associations with companies that receive calls from movers and aggregating the goods and services offered by these companies for offer during a single phone contact with a mover, and by providing a centralized call center where a mover's call can be received and these services offered, the system and method according to the invention provide a more efficient and effective solution to the existing problems of communicating an individual's change in address. Another aspect of the invention, is that large-scale mover demand for address-forwarding is aggregated from various channels into one transactional platform that targets movers across multiple points in the move timeline for related goods and services.

These two channels, also termed Direct Dial Inbound channel and Partner Call Transfers channel, act as complementary “push” and “pull” marketing strategies respectively to provide a source of callers. In combination with a consolidated call center, the method provides an effective and efficient method of communicating address changes.

Thus, it is an object of the invention to provide a system and method of communicating changes in address information without requiring a multiplicity of phone calls by the mover.

It is a further object of the invention to provide a marketing opportunity for businesses to offer products to movers according to the specific stage of moving.

An additional object of the invention is to provide customers with an efficient means of communicating address information and for receiving offers for appropriate services reflecting their needs.

Accordingly, a method of communicating a mover's address information is provided for receiving an inbound call from a caller, and obtaining address information of a mover. The address information may include an old address, a new address and a move date. The inbound call can be made on a toll-free number and can be received from a channel partner, from the mover, and can be made on a telephone number or an Internet address advertised such as in a media kit. The method provides that address information can be obtained during the call or otherwise and can be obtained through the mover or another.

The method also includes requesting identifying information of at least one correspondent from the caller and making an offer for services or products to the caller. The offer for services can include an offer for sale (including leasing) of a product or service by a sales partner. Further, the method provides for forwarding the old address, the new address and/or the move date to the correspondent or correspondents.

The method can also include determining a source of the call and obtaining address information based upon an associated script, where the associated script is associated with the source of the call. Similarly, the method provides that an offer for products or services can be based on an associated script and that the associated script can be associated with a mover's stage of moving, with a mover's sales history, and/or with the identity of the channel partner.

Another step of the method of communicating a mover's address information is requesting a mover's authorization to forward the new address to the correspondent or correspondents identified in the call. Similarly, a mover's authorization to forward a request for services to a sales partner can be requested.

The method can also include recording transaction information for billing sales partners. Accordingly, recording of transactions can reflect billing on a per acquisition basis, billing on a per lead basis, and/or billing on a per placement basis.

### BRIEF DESCRIPTION OF THE DRAWINGS

A more complete understanding of the present invention may be obtained from consideration of the following descriptions, in conjunction with the drawings, of which:

FIG. 1 is a representation of a system for communicating address information in accordance with the invention;

FIG. 2 is a flow chart showing several processing steps of the method for communicating address information according to the invention;

FIG. 3 is a flow chart showing several processing steps according to the method shown in FIG. 2;

FIG. 4 is an example of an interface display showing a welcome portion of a script according to the invention;

FIG. 5 is an example of an interface display showing a change of address information portion of a script according to the invention;

FIG. 6 is an example of an interface display showing a request for correspondent identification information portion of a script according to the invention;

FIG. 7 is an example of an interface display showing an offer of services portion of a script according to the invention; and

FIG. 8 is an example of an interface display showing an offer of ancillary services portion of a script according to the invention.

Throughout the figures, the same reference numerals and characters, unless otherwise stated, are used to denote like features, elements, components or portions of the illustrated embodiments.

### DETAILED DESCRIPTION OF THE PREFERRED EMBODIMENTS

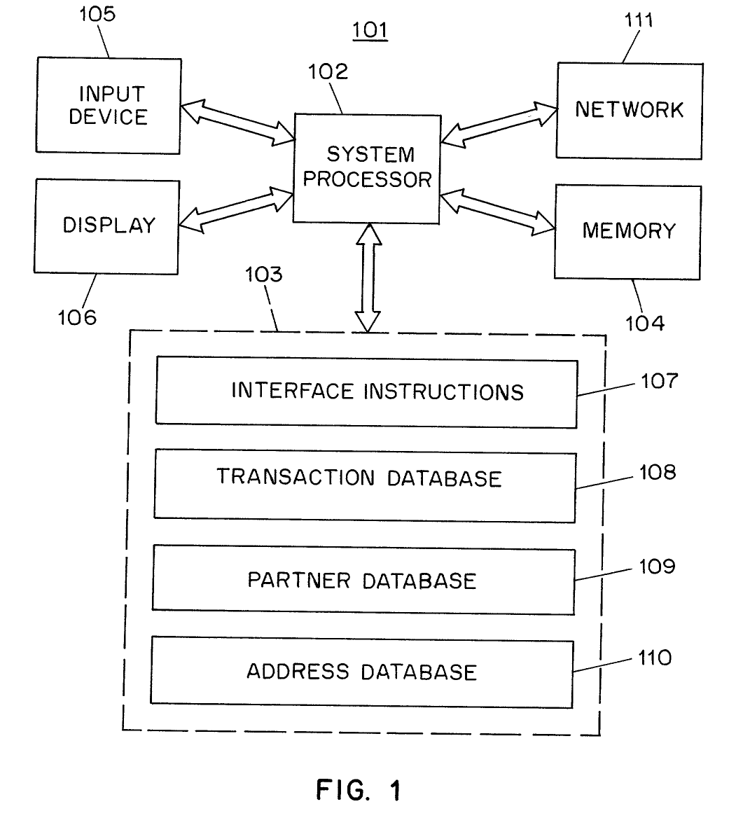

In order to solve the aforementioned problems, a method and system for communicating address information is provided. FIG. 1 shows one embodiment of a system 101 for communicating address information in accordance with the invention. The system is provided with a processor 102 for processing computer encoded instructions from a computer readable storage medium 103. The processor 102 can communicate with a computer memory 104 to facilitate processing of the instructions. In addition, an input device 105 can be provided for a user such as a call center representative to enter information or instruct the processor 102 to take certain actions in accordance with the instructions. The input device 105 can include one or more conventional input devices such as a keyboard or mouse pointing device. In addition, a display 106 can be provided to display to a user the instructions, associated data, or a graphical user interface (“GUI”) whereby a user can manipulate the instructions or data among other things.

The computer readable storage medium 103 provides instructions embodying portions of a method for communicating address information in accordance with the invention. The storage medium can be conventional computable readable storage such as removable magnetic media such as a disk but can also include optical media such as compact disks or electrical media such as RAM. The storage medium 103 is provided with interface instructions 107 for displaying to the user an interface for viewing a script of questions, for entering responses of a caller and for accepting instructions to process or communicate data, among other things. The specific instructions can be provided by one skilled in the art following the further detailed description of the method provided herein. A transaction database 108 can be provided for storing and retrieving information related to one or more inbound call transactions and can be used for billing of a partner. In addition, a partner database 109 can be provided for storing and retrieving information related to partner entities and other correspondents. Further, an address database 110 can be provided for storing and retrieving old and new address information of a mover as well as a move date. Although these databases have been described separately, it can be appreciated that the information can be stored and managed within a single, consolidated database and can be integrated with or managed by the interface instructions 107.

The system processor 102 can be in communication with a network 111 for communicating information with a mover at a computer (not shown) that is also in communication with the network 111. Furthermore, the network 111 can be in communication with a partner computer (not shown). The network 111 can be a phone network for participants to communicate orally, or it can be a computer terminated network, such as the Internet, for communicating information according to layered communication protocol. Where a variation of the system is provided for communicating with a mover's computer (not shown) over a computer terminated network such as the Internet, the interface instructions 107 can be specifically provided for displaying a GUI to a mover whereby change of address information can be entered by the mover and services can be offered to the mover.

A method in accordance with the invention can utilize a consolidated change of address (“COA”) system according to the invention to provide consolidated COA services to movers. The method according to the invention utilizes a consolidated COA process that integrates two marketing channels in order to initiate contact with a mover for offering consolidated services. The consolidated services allow movers to provide correspondents with their new address information in just one phone call to a call center. Correspondents include individuals, business entities and non-business entities with whom the mover corresponds. The method also provides a consolidated offer of services which permits businesses and institutions to offer additional or modified products and services within the same call.

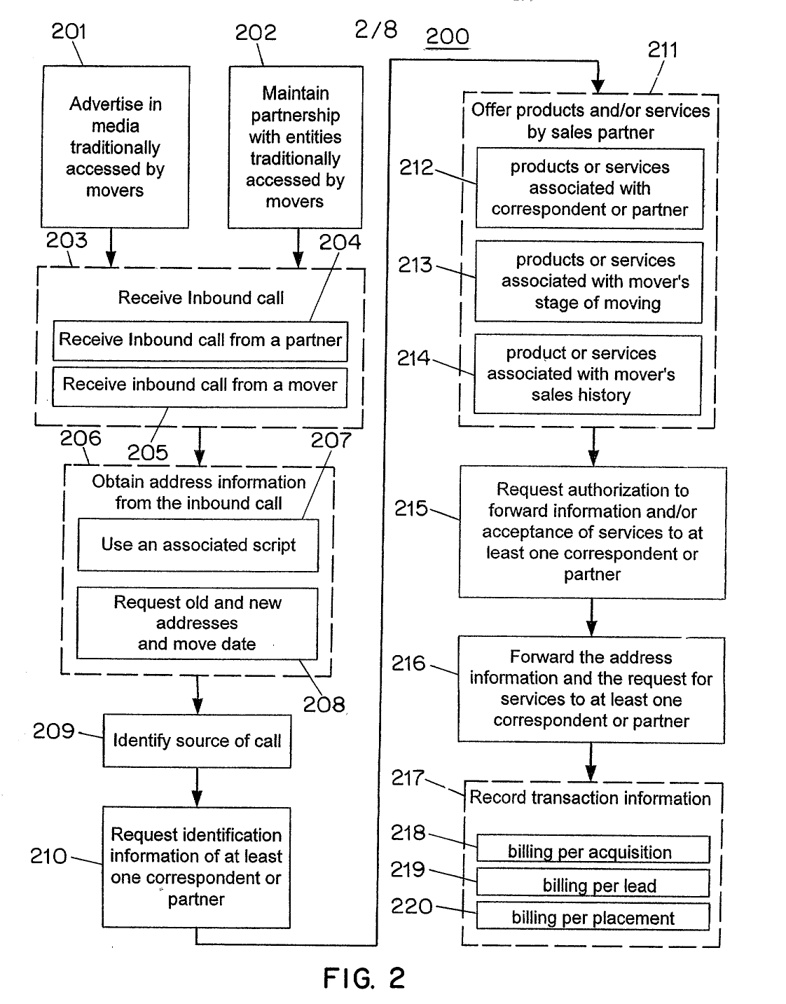

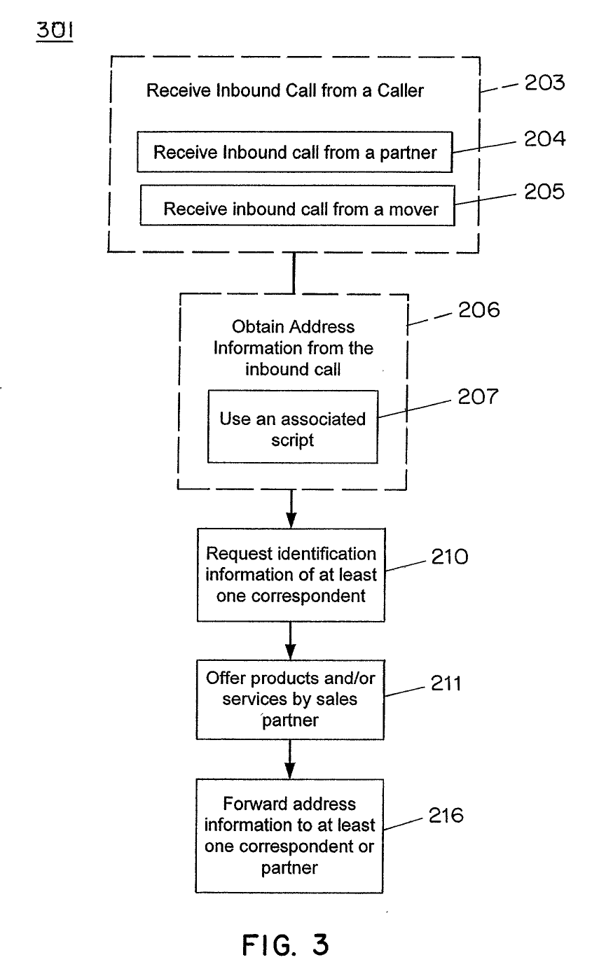

FIG. 2 is a flow chart that shows a series of steps wherein the consolidated COA process 200 utilizes multiple channels to provide access to movers at various move stages and to aggregate offers for additional or modified services into one transactional platform. In addition, a series of steps specifically adapted for use with the system 101 is shown in FIG. 3. Rather than trying to change mover behavior, the multiple channels provide contact with movers by accessing habitual and traditional activities associated with moving. In an embodiment, at least two marketing channels are provided. Step 201 in the process 200 establishes an advertising channel in media. Step 202 establishes a partnering channel wherein the partners including those groups, e.g., business entities, that movers have already become accustomed to transacting with in the move process in order to obtain transfer calls. The advertising channel can be from media advertisements from these partnering groups. The method provides contact with movers at early moving stages such as the planning and pre-move stages as well as the post-move stage through the partnering advertising channel and the advertising partnering channel with individuals and business entities with whom movers habitually or traditionally transact business. Thus, inbound calls from movers are preferably generated from at least two channels, i.e., the advertising channel which provides direct contact with the mover, and the partnering channel which provides transferred mover calls from a partner.

The first marketing channel, the advertising channel in step 201, attracts direct calls from movers through advertising in media, preferably media traditionally accessed by movers and may include without limitation newspapers, magazines, radio and television. The advertisement preferably provides at least one phone number or Internet address and may also provide information about the consolidated services offered. The advertisement can indicate that the service is free to the mover and can indicate that the number is toll-free. In one example, the advertisement can specifically state that through one free call, a mover can have the delivery address of all of the mover's mail changed to be addressed to the new address. In another example, the advertisement can state that through one free call, a mover can have one type of mail rerouted, e.g., the delivery address of all of the mover's magazine subscriptions changed. The service can be featured by the advertisement as a one-step solution for all (or partial) change of address activities, as well as a service for providing the mover with an opportunity to modify or add services provided by correspondents and businesses. The form of the advertisement should provide sufficient information for a mover to contact the call center. For example, providing an Internet address can be enough information for providing access to the call center where the Internet address has further contact information.

When a mover dials a phone number provided in such an advertisement, a consolidated call center is reached for receiving the mover's change of address information, among other things. The phone number can be one of several numbers, all of which are directed to the call center and can be toll-free. Separate phone numbers can be used to identify the specific advertisement in which the number was published or a group of advertisements including the specific advertisement, and thus can better identify the source of the call. Similarly, additional Internet addresses can be used in advertisements to provide source information.

Media in which advertisements can be featured are preferably those to which a mover refers during early moving stages. For example, in the early stages of moving, such as in the planning and pre-move stages, a mover typically contacts a real estate broker to assist with the search for a new residence. Traditionally accessed media appropriate for advertisement can include real estate broker brochures and apartment lists published in paper or electronically on the Internet. Among real estate brokers, it is preferable that arrangements for advertising are made with major residential franchisers. In addition, since corporations often provide their employees with relocation assistance supported by relocation service providers, advertisements of the services can be included to appear as an added-value service in the moving materials provided by such relocation services.

As a further example of utilizing traditionally accessed media or services, relocation providers can be utilized for advertising the consolidated COA services within their media channels. The advertisement can also be displayed in publications such as moving kits, e.g., the new mover's guides and the welcome kit which are provided in United States Post Office branches. Movers have traditionally gone to the Post Office to complete a change of address form which is typically included in the guide. An inbound call can also be triggered through advertisements in sweepstakes direct mail.

An Internet advertisement can be provided to give a mover a phone number to call or the advertisement can provide a link or an Internet address to a network hosted interface that emulates the functions of the call center. The interface instructions 107 can provide the mover with a conduit of communicating change of address information and selection of services directly with a system maintained by the consolidated call center.

Advertising by entities controlling advertising media can be arranged through formal or informal association, and thus comprise a number of channel partners through which contacts with movers are channeled. A contract with the channel partner can be provided specifically to promote the consolidated COA process through the media providers' publication. Preferably, a contractual relationship is used to formally ensure the advertising channel step 201 of the process at early stages of the mover timeline. The billing of the advertising services can reflect the effectiveness of this transactional model by tying revenue derived from numbers called in response to the advertisement of the number. Thus, one marketing channel by advertising 201 comprises the “push” that generates a source of direct inbound calls by movers to the call-center.

The second marketing channel, the partnering channel step 202, attracts mover's calls by creating and maintaining partnerships with either channel partners providing media advertisements or channel partners only providing call transfers. Accordingly, the partnering channel uses entities (channel partners) who agree to transfer a mover's call received by the channel partner to the consolidated call center. Partnership channel agreements for transferring a mover's inbound call preferably recognize the benefit to the channel partner with whom movers typically interact. The direct benefit is the reduced need for partners to staff call centers of their own.

Partner relationships are made, for example, with channel partners such as businesses that movers traditionally contact during the initial phases of the moving process. Channel partners can provide both media for advertisements as well as transfers of mover's direct calls. Although partners are those that the mover typically contacts during the planning and pre-move phases, they can also include entities with whom movers contact in other stages, such as the settling-in stage. For example, associations with utility companies can provide a partnership through which the utilities would agree to transfer a mover's request to change services by transferring such calls to the call center. Phone and other communication companies, banks and real estate agents can be partners for transferring a mover's inbound call or they can provide an opportunity for advertising as discussed above. Other types of partners can include businesses involving auto insurance, life insurance, credit cards and credit lines, home security, local newspapers, credit unions, check printing, affinity memberships, magazine subscriptions, refuse removal, co-op direct mailers, sellers of consumer product goods and distributors of sampling programs, among others.

Partnership agreements may provide that when a channel partner is contacted by a mover to change the services provided by the partner, the partner requests whether the customer/mover would like to utilize the consolidated services offered by the call center. If the customer agrees, the partner transfers the mover's call to the call-center of the consolidated services. Alternatively, the partnership agreement can provide that the mover's call is transferred before the business with the partner is concluded. In this situation the partnership agreement can allow the consolidated call-center to act on behalf of the partner to complete business with the mover such as transferring service to the new address, as well as offer additional products and services. Thus, the partnering channel step 202 comprises a “pull” marketing program that cooperates with the “push” of the advertising channel step 201 and thereby provides a combined process of attracting movers to a consolidated call center at early stages in the move timeline.

The partnership agreements with channel partners can be formal or informal agreements but are preferably binding contractual obligations to ensure access to the partnership channel step 202 for obtaining contact with movers. One billing method can be to structure partnerships with a revenue sharing or a “pay-per-call” arrangement whereby revenue derived from sales of products or services during the call are shared with the channel partner who transferred the call.

A call center is provided by the consolidation process 200 for receiving inbound calls from movers and channel partners. Accordingly, step 203 in the consolidated COA process 200 is to receive calls from movers and channel partners. Inbound calls can be received from partners 204 and received from movers 205 either separately or together. The call center can be provided with means to distinguish the source of the calls, such as by using a caller ID feature with a phone line, in order to process each inbound call as further described herein. The call center can exist at one or more locations where representatives and receiving systems are provided for managing inbound calls, accessing and entering information into the databases of the systems, and for forwarding address change information to correspondents.

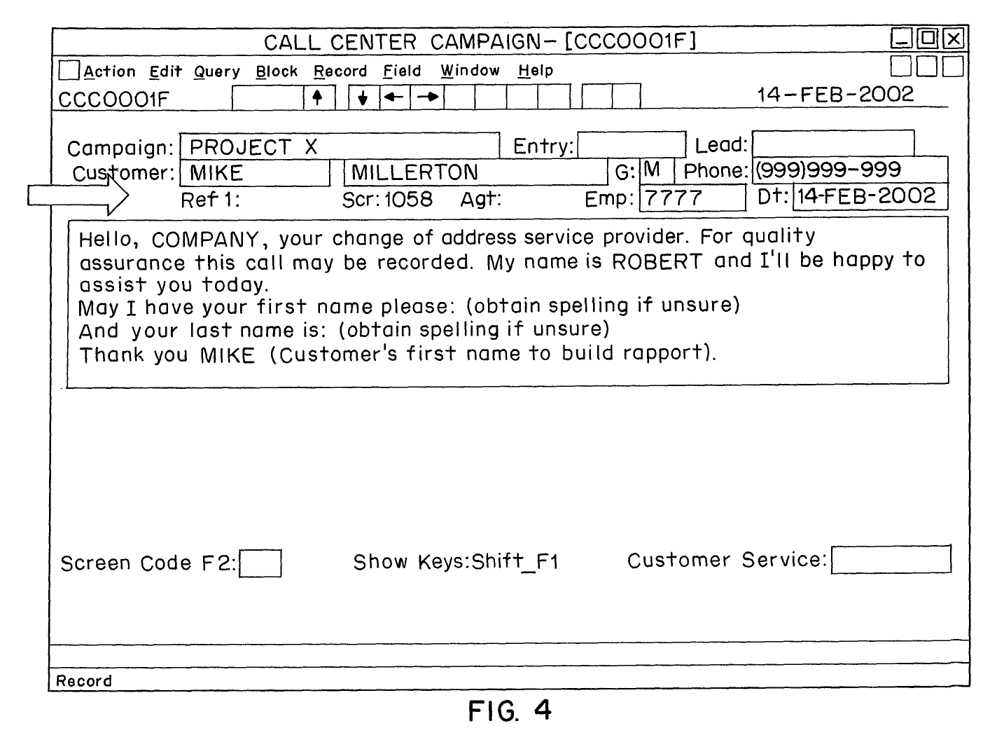

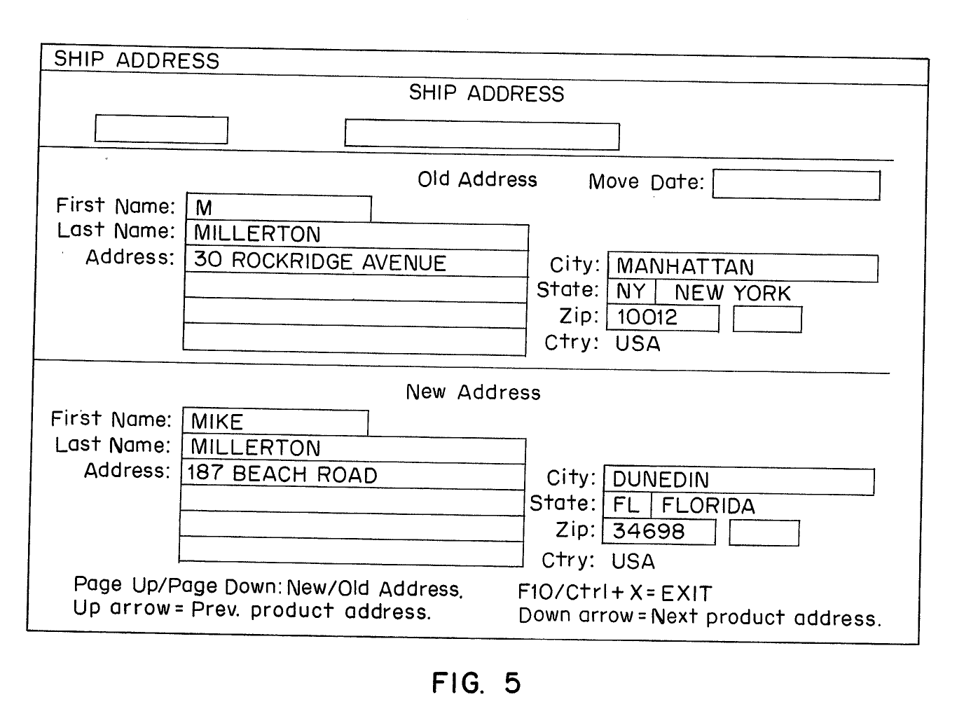

At step 206, a representative at a call center is provided to obtain address information from the inbound call 206. To structure the dialog with a mover, the representative can use a script 207 which can include a series of questions to be presented to the mover. The associated script may be from one or more scripts specifically adapted to the tracking information. Each script provides a tailored series of questions that are associated with certain types of tracking information. An example of a portion of a script is shown in FIG. 4. At step 208 of the process 200, the representative requests and can record the mover's new and old addresses, and the mover's expected move date. As shown in FIG. 5, the interface instructions 107 can provide an interface whereby the representative, or online mover, can enter this information which can be stored in the address database 110. The interface instructions can be provided at least in part as a network accessible medium whereby a user, such as a mover, can access a network interface for entering moving information or contacting the call center. The network interface can provide a separate channel for communicating with an interface and can utilize a web browser, PDA, or “click-to-call” technologies, among other things.

In addition, at step 209, the representative and/or receiving systems can obtain the identification of the source of the call, such as whether the call is made directly from a mover or has been transferred by a channel partner. This information can be stored as tracking information in the address database 110 or in a separate database.

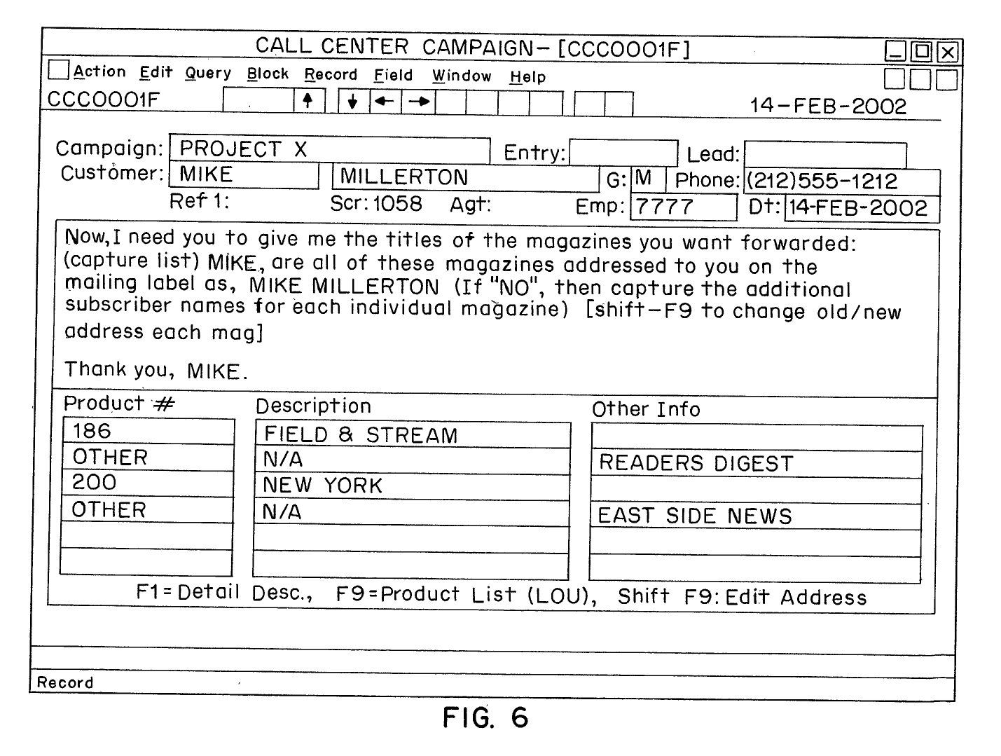

Identifying information of at least one correspondent or partner is requested at step 210. This request can be provided as part of an associated script presented to a call center representative in order to obtain and record identifying information of correspondents of the mover. These correspondents can include channel partners, individuals, non-business entities and businesses such as credit card companies, insurance providers, banks and magazines. Generally, correspondents are entities with whom the mover has accounts and to whom the mover desires to forward address change information. As shown in FIG. 6, the interface can be provided with entry fields for entering correspondent information into the system for storage.

At step 211, products and/or services are offered by one or more sales partners. Sales partners can include channel partners but can include other individuals, businesses, and non-business entities who wish to offer products and/or services through the consolidated COA system and method. Examples of sales partners include customer-centric companies.

Accordingly, a representative of the call center can offer products and services by one or more sales partners to the mover. Thus, in addition to providing the mover with a free consolidated service, the system and method benefit partners by creating a unique marketing window during an inbound call wherein products and services can be marketed to the partner's customer base. In this way, a channel partner can save on the cost of maintaining a fully staffed call center and still obtain additional revenue through offering additional service by having the consolidated call center handle offers for products or services ancillary to the partner's primary services. For example, services for a phone company can include service maintenance plans, call waiting, call forwarding and caller-ID. Similarly, for cable and satellite service providers, upgraded services can be offered to movers by the consolidated call center during the inbound call as well as other services such as Internet connectivity.

One function of the call center is designed to maximize the opportunity to centralize changes in services during an inbound call. Accordingly, a benefit afforded by such a call center is providing for quality representatives receiving the call and communicating with the mover. In addition, because a database of mover information can be maintained by the call center, the system provides that redundant questions about services can be avoided. Further, appropriate questions about services can be made to the mover based upon the mover's stage of moving and reflecting any information about the mover's prior services with a partner or correspondent. Accordingly, a step in the process 200 can be to offer products and/or services associated with a mover's stage of moving. To this end, a specific script can be provided that reflects the stage or where in the timeline the mover is in, as well as the effective date of the move. Similarly, another step in the process can be to offer products and/or services associated with a mover's sales history. These aspects of the invention are described further below where tracking information is described to provide an associated script for sales offers.

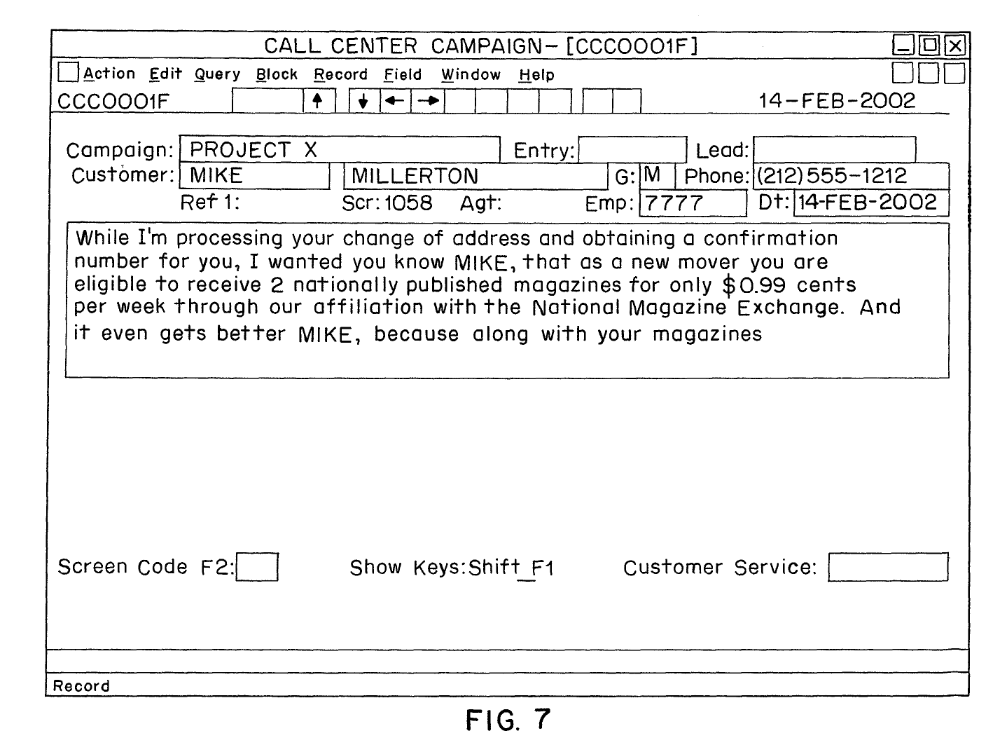

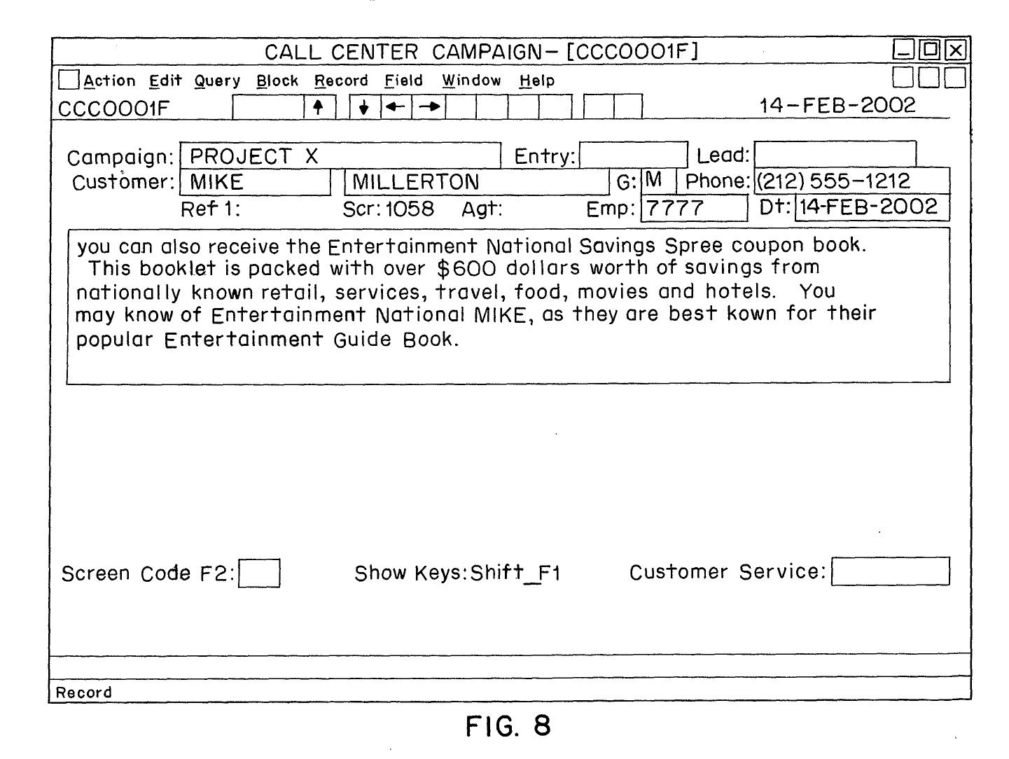

Since mover channels include print and direct marketing pieces as well as call transfers, scripts can reflect that the inbound call originates from such sources. Accordingly, step 212 in the consolidated process 200 can be to offer services associated with channel partner. As shown in FIG. 7, an interface can be provided as part of the script wherein an offer associated with a marketing channel can be shown. Similarly, FIG. 8 shows an associated offer by a sales partner. The call center can offer multiple products to ensure that a mover's needs are met from a ready catalog of product and service offerings. In addition, the call center can sell alternative products to a repeat caller based upon service history. The system thus maximizes the value of the inbound call by offering the right product to the right caller.

Tracking information can be used to determine what products or services to offer a mover based on the mover's the stage of moving and sales history, among other things. One way is by associating a unique telephone number or Internet address, (e.g., URL or web address, etc.) with the media marketing channel within which that the consolidated process 200 solution had been advertised and identifying the source of the call (step 209). A unique toll-free number can automatically generate an associated script to be displayed on an interface that is specific to the telephone number or Internet address the mover used to reach the call center and offer associated products or services at step 212. For example, the script can be customized for a particular telephone number or Internet address and to allow a representative of the call center to read from the interface the series of questions and offers associated with the script. As an example, a mover who receives a brochure from their real estate agent, may call the toll-free number from the brochure. Since the telephone number can be specific to that real estate agency and to that brochure, when the customer calls the call center, the receiving system can recognize the incoming number and can generate a script that includes information relevant to the real estate agency and can provide offers relevant to the mover's stage of moving. The script could include a greeting such as “Thank you for calling the Call Center, your change of address provider. We are glad you chose Company X as your preferred real estate agency.” At step 213, the script can also offer goods and services associated with the mover's stage of moving. For example, if the mover has just purchased a home and is getting ready to move, one such offer could include “As you are getting ready to move into your new home would you like to hear about a special offer we have from the XYZ Moving Company?” Another appropriate offer, such as to connect services in the new home, can be provided in the script as “Would you like to set up your local and long distance service at your new home now?”

Another way of determining a script associated with the stage of moving is through change of address information. Each time a mover contacts the call center to provide change of address information, they are asked to provide an effective date that the new address will become active, or the date the mover intends to move into the new home. This information allows the consolidated process 200 and system 100 to track the customer on a mover timeline based on the move date. Accordingly, at step 214, there can be an offer of services associated with the mover's sales history. For example, a general move timeline can account for the general need to connect new cable service two weeks prior to the move to ensure cable service at the move date. The system 100 can determine the date for requesting this service charge from the effective date of the move. If the mover contacts the call station two weeks or less from a provided consolidated move date, the system 100 can generate a script that includes a cable offer. If the mover provides a move date earlier than that, such as a month prior to the move, the scripts according to the consolidated COA system can record this information and set an automatic prompt to generate an outbound call two weeks later for offering cable service at that time. As a further example, the timeline can account for the general need to update car insurance within sixty days of moving to the new home, and accordingly, the system can generate an automatic prompt to send an outbound call thirty days after the move date for offering an car insurance update.

At a later point in the script, another step of the consolidated COA process 200, step 215, can be provided wherein a representative at the call center can request authorization from the mover to forward address change information to correspondents and/or to authorize the acceptance of products and/or services offered by the sales partners. As a further step of the consolidated process, the change of address information and request for services or products, if any, can be forwarded to correspondents and partners at step 216.

Since the call is free to the mover, software code for accounting instructions can be provided with the interface instructions 107 to account for transactions for later billing of partners. Accordingly, another step 217 in the process 200 can be provided to record transaction information for capturing each transaction with movers. Transaction information includes the identity of the mover, the products or services provided, the date of the sales and the identity of the sales partner, among other things. Alternatively, the accounting instructions can be provided separate from the interface instructions 107.

One billing arrangement that can be used as a step in the consolidated process 200 is the step 218 of billing on a per acquisition basis. By this method, sales partners whose services or goods are promoted are charged each time a mover agrees to purchase or subscribe to the partner's goods or services. For example, a long distance company would be billed by every time a mover agrees to accept a new long distance service as a new customer.

Another billing arrangement that can be used is the step 219 in the consolidated process 200 of billing on a per lead basis. By this method, sales partners whose goods and services are promoted are billed for receiving information on every customer that expresses an interest in the partner's goods or services. For example, a home furnishings catalog company may be interested in sending a catalog to movers who indicate they are interested in purchasing new furniture when they move. In this case, the partner is billed for each mover referral. As another example, the partner may be interested in customers who fit a certain profile without regard as to whether they express an interest in a product or not. Accordingly, if the catalog company only operated within in a certain region, for example, they could be billed per lead for movers who are moving into that specified region.

Another billing arrangement that can be used in the consolidated process 200 is the step 220 of billing on a per placement basis. By this method, partners and correspondents whose goods and services are promoted are billed per placement of the partners' advertisement or offer for sale. For example, when a mover contacts the call center and provides change of address information, the call center can send that mover a confirmation letter or E-mail with the change of address information that includes, encloses or attaches the partners advertisement for products or services. Accordingly, the partner is billed under this method for every letter or E-mail containing its advertisement.

The receiving system for the consolidated system and method for communicating individual address information provides the means for a call center to receive, identify, and distribute inbound calls from movers. The receiving systems can be supported by a Rockwell Spectrum switch for an automated call distributor as provided by Rockwell Automation (300 Bauman Court, Wood Dale, Ill. 60191). Each inbound station can be equipped with CTI (Computer Telephony Integration), also provided by Rockwell, that allows voice and data to pass to subsequent call center representatives. The call center can be provided with real-time access to multiple management tools including call flow and sales activity that permit the efficient utilization of call-center representatives. Predictive workforce scheduling can also be used for forecasting inbound calls and to ensure sufficient numbers of representatives.

A transactional platform can be provided and integrated with the interface instructions 107 for online credit verification at the point of sale, as well as for managing recurring billing for multi-part orders and automatic renewal for continuous service. In addition, credits and chargebacks can be processed by the call center and customized billing descriptors for credit card statements can be generated. Billing options can be further enhanced by providing pay-by-check and invoicing capabilities.

One of ordinary skill in the art would be able to program variations to the routines in FIGS. 2 and 3 without deviating from the spirit and scope of the invention. The interface instructions 107 having the instructions for generating the computer-assisted portions of the method and system can be programmed using JavaScript, VBScript, Visual Basic, or the C programming language, among other programming languages. The summary interface instructions 107 can be incorporated into regular use with other graphical user interfaces or it can be provided as an independent unit such as by programming the interface as part of a dynamically-linked library. The databases, such as the transaction database 108, the partner database 109 and address database 110 can be provided separately or as an integrated database using commercially available database software such as is provided by Equifax (1550 Peachtree Street, N.W., P.O. Box 4081, Atlanta, Ga. 30309).

The invention has been described in connection with certain preferred embodiments. It will be appreciated that those skilled in the art can modify such embodiments without departing from the scope and spirit of the invention that is set forth in the appended claims. Accordingly, these descriptions are to be construed as illustrative only and are for the purpose of enabling those skilled in the art with the knowledge needed for carrying out the best mode of the invention. The exclusive use of all modifications and equivalents are reserved as covered by the present description and are understood to be within the scope of the appended claims.

We claim:

1. A method of communicating a mover's address information comprising the steps of:
receiving an inbound call from a caller;
obtaining address information of a mover, wherein the mover's address information includes a new address;
requesting from the caller identifying information of at least one correspondent;
making an offer for at least one of a product and a service; and
forwarding at least a portion of the address information to the at least one correspondent.

2. A method of communicating a mover's address information according to claim 1 wherein the address information includes an old address.

3. A method of communicating a mover's address information according to claim 2 wherein the address information includes a move date.

4. A method of communicating a mover's address information according to claim 3 wherein the address information forwarded to the at least one correspondent includes the new address, the old address and the move date.

5. The method of communicating a mover's address information according to claim 1 wherein the offer includes an offer for sale of at least one of a product and a service by a sales partner.

6. The method of communicating a mover's address information according to claim 1 wherein the inbound call is made on a toll-free number.

7. The method of communicating a mover's address information according to claim 1 wherein the inbound call is received from a channel partner.

8. The method of communicating a mover's address information according to claim 1 wherein the inbound call is received from the mover.

9. The method of communicating a mover's address information according to claim 1 wherein the inbound call is made on at least one of a telephone number and an Internet address included in an advertisement.

10. The method of communicating a mover's address information according to claim 9 wherein the advertisement is in a media kit.

11. The method of communicating a mover's address information according to claim 9, wherein the advertisement is in a moving kit.

12. The method of communicating a mover's address information according to claim 1 wherein the step of obtaining address information of a mover is made during the inbound call.

13. The method of communicating a mover's address information according to claim 1 wherein the step of obtaining address information includes obtaining address information of the mover from the mover.

14. The method of communicating a mover's address information according to claim 1 further comprising determining a source of the call.

15. The method of communicating a mover's address information according to claim 14 wherein the step of obtaining address information includes obtaining address information of the mover based upon an associated script, wherein the associated script includes a plurality of questions associated with the source of the call.

16. The method of communicating a mover's address information according to claim 1 wherein the step of making the offer includes making the offer based on an associated script.

17. The method of communicating a mover's address information according to claim 16 wherein the associated script is selected at least in part based on a mover's stage of moving.

18. The method of communicating a mover's address information according to claim 16 wherein the associated script is selected at least in part based on the mover's sales history.

19. The method of communicating a mover's address information according to claim 16 wherein the associated script is selected at least in part based on the identity of a channel partner.

20. The method of communicating a mover's address information according to claim 1 further comprising requesting an authorization from the mover to forward the new address to the at least one correspondent.

21. The method of communicating a mover's address information according to claim 1 further comprising requesting an authorization from the mover to forward a request for at least one of a service or a product to a sales partner.

22. The method of communicating a mover's address information according to claim 1 further comprising recording transaction information.

23. The method of communicating a mover's address information according to claim 22 wherein the step of recording transaction information includes billing a sales partner on a per acquisition basis.

24. The method of communicating a mover's address information according to claim 22 wherein the step of recording transaction information includes billing a sales partner on a per lead basis.

25. The method of communicating a mover's address information according to claim 22 wherein the step of recording transaction information includes billing a sales partner on a per placement basis.

26. The method of communicating a mover's address information according to claim 1 wherein the offer is for one of a product or a service of the at least one correspondent.

27. A method of communicating a mover's address information comprising the steps of:
receiving an inbound call from a mover;
obtaining address information of the mover during the inbound call, wherein the mover's address information includes a new address, an old address, and a move date;
requesting from the mover identifying information of at least one correspondent;
making an offer for at least one of a product and a service;
forwarding at least a portion of the address information to the at least one correspondent; and
requesting an authorization from the mover to forward the new address to the at least one correspondent.

28. The method of communicating a mover's address information according to claim 27 further comprising determining a source of the call.

29. The method of communicating a mover's address information according to claim 28 wherein the step of obtaining address information includes obtaining address information of the mover based upon an associated script, wherein the associated script includes a plurality of questions associated with the source of the call.

30. The method of communicating a mover's address information according to claim 29 wherein the step of making the offer includes making the offer based on an associated script.

31. The method of communicating a mover's address information according to claim 30 wherein the associated script is selected at least in part based on a mover's stage of moving.

32. The method of communicating a mover's address information according to claim 31 wherein the associated script is selected at least in part based on the mover's sales history.

33. The method of communicating a mover's address information according to claim 32 wherein the associated script is selected at least in part based on the identity of a channel partner.

34. A system for executing a computer program for communicating a mover's address information comprising:
a memory device for storing the computer program thereon; and
a data processor which
maintains a database of address information;
receives an inbound call from a caller;
displays an associated script, wherein the associated script includes a plurality of questions, and wherein the plurality of questions includes at least one offer for at least one of a product or a service;
receives a mover's address information according to the associated script, wherein the address information includes an old address, and a new address;
saves the address information in the address database; and
receives an identity of at least one correspondent of the mover.

35. A computer usable medium comprising a computer program code which is configured to cause a processor to execute at least one function comprising:
maintaining a database of address information;
receiving an inbound call from a caller;
displaying an associated script, wherein the associated script includes a plurality of questions, and wherein the plurality of questions includes at least one offer for at least one of a product or a service;
receiving a mover's address information according to the associated script, wherein the address information includes an old address, and a new address;
saving the address information in the address database; and
receiving an identity of at least one correspondent of the mover.
